(19) United States
(12) Patent Application Publication
(10) Pub. No.: US 2004/0066402 A1
(43) Pub. Date: Apr. 8, 2004

(54) Circuit device provision system and server computer

(76) Inventors: Eiju Maehara, Kiryu-shi (JP); Junji Sakamoto, Ora-gun (JP); Noboru Usui, Oota-shi (JP)

Correspondence Address: FISH & RICHARDSON P.C., 45 ROCKEFELLER PLAZA, SUITE 2800, NEW YORK, NY, 10111, US

(21) Appl. No.: 10/675,690

(22) Filed: Sep. 30, 2003

(30) Foreign Application Priority Data
Oct. 2, 2002 (JP) 2002-290426

(51) Int. Cl. G09G 5/00

(52) U.S. Cl. 345/744

(57) ABSTRACT

A system for providing a circuit device having no support substrate and which covers and supports a circuit element by an insulating resin. A device manufacturer and a part manufacturer are connected to an ISB server via the Internet. The user (device manufacturer) inputs conditions to be satisfied by a desired ISB through a user terminal and transmits these specifications to the ISB server via the Internet. The ISB server accumulatively stores the received specifications and provides manufacturing data, for example, mask data and part arrangement data for manufacturing an ISB based on the received specifications, to an ISB mounting factory. The ISB mounting factory manufactures an ISB based on the supplied manufacturing data and provides the ISB to the user. A part manufacturer supplies, via the Internet, data of a part which can be used in an ISB and registers the part data in a database.

### BACKGROUND OF THE INVENTION

1. Field of the Invention

The present invention relates to a circuit device provision system and a server computer, and, in particular to a technique for providing, via a communication network or the like, a circuit device in which an active part and a passive part are covered and supported by an insulating resin.

2. Description of the Related Art

Recently, instead of separately packaging each semiconductor element as was previously done, techniques are developed in which a plurality of circuit elements such as an IC, an LSI, and a chip resistor are packaged in one package and supplied as a system. These techniques are known as SIP (System in Package) or ISB (Integrated System in Board). Techniques for providing a system as one package can generally be classified as one of a PCB mounting, system LSI, or ISB technique. PCB mounting suffers problems in that it is difficult to reduce the size and weight and to obtain high performance. Although a system LSI has advantages that it is possible to reduce the size and weight, to obtain high performance, and to reduce power consumption, the system LSI suffers problems in that changes to the specification are difficult and development of a new system is very expensive. On the other hand, the ISB has the advantages of the system LSI in that it is possible to reduce size, weight, and power consumption and, in addition, has an advantage that it is possible to quickly respond to a change in the specification. More specifically, while in a system LSI, an SOC chip in which a plurality of functions are integrated is formed and mounted on a substrate, in an ISB, a system is constructed by connecting a plurality of chips by a multi-layer wiring. Thus, it is possible to flexibly respond to changes in specifications by changing the chip and wirings in an ISB.

FIGS. 15 and 16 show, respectively, a perspective view and a side view of an ISB circuit device. In an ISB circuit device, unlike in a PCB mounting, a plurality of circuit elements are embedded into an insulating resin package and there is no support substrate such as a print substrate in the PCB mounting. A circuit element such as an LSI bare chip 52A, a chip CR 52B, and a Tr bare chip 52C are fixed onto a conductive path 51 such as a copper pattern using a conductive paste 55B and are covered and integrally supported by an insulating resin 50. In other words, the insulating resin 50 functions to cover the plurality of circuit elements, and, at the same time, as a supporting member of the circuit elements. The LSI bare chip 52A or the like are wire-bonded by a gold line bonding 55A. The conductive path 51 is exposed on the backside of the ISB circuit device and a solder ball 53 is connected.

FIGS. 17-20 show a method for manufacturing an ISB circuit device. As shown in FIG. 17, a sheet-shaped conductive foil 60 is prepared and a photo resist (etching-resistive mask) PR is formed on the conductive foil 60, and the photo resist PR is patterned so that the conductive foil 60 exposes in regions other than a region which forms the conductive path 51.

Next, as shown in FIG. 18, the conductive foil 60 is etched using the photo resist PR as a mask to form a separation channel 61. The thickness of the conductive foil 60 can be set in a range from 10 μm to 300 μm (for example, 70 μm) and the depth of the separation channel 61 can be set to, for example, 50 μm. As the etching, for example, a wet etching process, a dry etching process, and evaporation by laser can be employed.

Then, as shown in FIG. 19, circuit elements such as the LSI 52A and chip CR 52B are mounted on the conductive foil 60 on which the separation channel 61 is formed. The bare LSI chip 52A is fixed by a conductive paste 55B and the chip CR is fixed by a soldering member such as solder or by a conductive paste. The terminal of the LSI 52A is wired by a metal fine line 55A.

Next, as shown in FIG. 20, an insulating resin 50 is attached to the conductive foil 60 and the separation channel 61. The insulating resin 50 is an epoxy resin, a polyimide resin, or the like, and is formed through transfer molding or injection molding. The thickness of the insulating resin 50 covering the surface of the conductive foil 60 is adjusted, for example, such that approximately 100 μm from the top portion of the circuit element is covered. Then, the backside surface of the conductive foil 60 is chemically or physically removed and separated as the conductive path 51. In FIG. 20, a surface exposed by the removal is shown by a dotted line. For example, the conductive path 51 is separated by grinding the backside surface by approximately 30 μm using an abrasive or a grinder. Finally, a solder ball is connected to the exposed conductive path 51 to complete the ISB circuit device.

FIGS. 21A-21C show another ISB circuit device 70. As shown in FIG. 21A, in this circuit, a current mirror circuit made of transistor chips TR1 and TR2 and a differential circuit made of transistor chips TR3 and TR4 are integrated. Four transistor chips TR1-TR4 are bonded by a Au fine line. As shown in FIG. 21C, a die pad 71 on which a Z film (a film having a larger growth in the thickness direction than in the planar direction) 74 is formed, a bonding pad 72 on which a Z film 74 is formed, a die pad, and a bonding pad are electrically connected by a wiring 73. As the wiring 73, a rolled copper foil may be used. Because the rolled copper foil is resistive against repetition of bending by heat, the rolled copper foil inhibits disconnection of the wiring.

Additional explanation can be found in Japanese Patent Laid-Open Publications Nos. 2001-217338 and 2002-93847.

An ISB circuit device has many advantageous characteristics such as lightweight, thin width, small size, higher degree of freedom for the package shape, relatively short development period, high thermal discharge characteristic because the lower side of the chip is directly exposed, superior high-frequency characteristic because there is no core member and the wiring has low dielectric constant, etc. Conventionally, a manufacturer uses conventional communication means, such as paper documents, to communicate to an ISB manufacturer specification data which must be satisfied by an ISB circuit device to be included in a device (for example, a portable phone, a digital camera, etc.). Then, the ISB manufacturer manufactures a sample ISB circuit device based on the specification and delivers to the device manufacturer (It should be noted that as used herein, a device manufacturer is not limited to a manufacturer that produces consumer goods in their final form, but can be an intermediate manufacturer, such as a manufacturer or assembler of components). In this configuration, there is a problem in that advantages of the general-purpose property and expandability of the ISB circuit device are not fully exploited.

For example, it is desirable for the device manufacturer to be able to more easily and more flexibly provide the specification of the ISB which the device manufacturer desires to the ISB manufacture. In addition, when it is possible to obtain the LSI and chip parts used in an ISB circuit device from a plurality of manufacturers instead of a particular manufacturer who is a contractor of the ISB manufacturer, an ISB circuit device can be provided to the device manufacturers more quickly and cheaply when parts are obtained from a larger number of competitive part manufacturers. Furthermore, a system is preferable in which the device manufacturer who is the user of the ISB circuit device does not completely rely on the ISB manufacturer for the design of the ISB, but rather the device manufacturer can to some extent be involved in the designing of the ISB. Such a system significantly increases the ease of use of the ISB. In the conventional flow in which the ISB manufacturer manufactures a sample based on a specification from the device manufacturer, these various demands cannot be satisfied.

### SUMMARY OF THE INVENTION

The present invention advantageously provides a system which can effectively and quickly supply various circuit devices to a user.

According to one aspect of the present invention, there is provided a system for providing a circuit device to a user using a server and a user terminal connected to a communication network, wherein the user terminal comprises input means for inputting a condition to be satisfied by the circuit device; and transmission means for transmitting the condition via the communication network to the server, the server comprises receiver means for receiving the condition transmitted from the user terminal; storage means for storing circuit device data related to the circuit device; processor means for providing at least a portion of the circuit device data to the user terminal as a sample and for creating manufacturing data of the circuit device based on the condition received from the user terminal and the circuit device data; and output means for outputting the manufacturing data to a manufacturing facility of the circuit device, and the storage means stores, as the circuit device data, at least CAD data of circuit diagram, CAD data of a built-in passive part, CAD data of a built-in active part, adhesive data, external form data, and backside terminal data regarding the circuit device.

In a system according to one aspect of the present invention, a user provides conditions of a circuit device to a server through a communication network and the server creates manufacturing data based on the received conditions and transmits the manufacturing data to a manufacturing step. When the manufacturing data is created and when the user inputs the conditions, various data stored in storage means (database) are referred to.

According to another aspect of the present invention, it is preferable that, in the system, the user terminal transmits, as the condition, at least external form and size data, terminal data, built-in part data, and CAD data of circuit diagram regarding the circuit device to the server, and the server creates manufacturing mask data as the manufacturing data based on the condition. In an ISB circuit device or the like, as described above, an etching mask is formed on a conductive foil using a photo resist PR and a conductive path is formed using the etching mask. In general, the mask data can be automatically created from the external size of the circuit device, terminal data, data of built-in parts, and CAD data of a circuit diagram. Additional data may also be input as additional conditions. The manufacturing mask data is provided to a facility for manufacturing the circuit device, a mask is created in the circuit device manufacturing facility based on the mask data, and a circuit device is manufactured using the mask. The user can obtain a desired circuit device by merely inputting the conditions of the circuit device from a user terminal.

According to another aspect of the present invention, it is preferable that, in the system, the storage means accumulatively stores the condition received from the user terminal and the manufacturing data. In addition to be used for creating the manufacturing data, the conditions received from the user terminal may be provided for use by another user terminal. In other words, when a plurality of user terminals are connected to the communication network, it is possible to configure the system such that conditions input from a user terminal and stored in the storage means can be viewed from another user terminal in order to allow another user to use the data as a reference for inputting conditions for their own circuit device and use that data as basic data design of a circuit device. It is also possible to allow the user terminal through which the conditions were input to determine whether or not to allow the conditions stored in the storage means to be viewed through other user terminals. In addition, by accumulatively storing the manufacture data, it is possible to refer to, when new conditions are input, the manufacturing data created in the past, resulting in an easier creation of manufacturing data based on the new conditions.

According to another aspect of the present invention, it is preferable that, in the system, the storage means further stores data of reliability evaluation results for a plurality of circuit devices, and the processor means evaluates the reliability of the circuit device to be manufactured from the received condition based on the reliability evaluation result. Conditions of the circuit device are transmitted from the user terminal to the server and the server creates manufacturing data based on the conditions and provides the manufacturing data to a manufacturing facility for the circuit device. In actual operation, a certain period of time is required until a circuit device is completed and there are cases in which a user wishes to more quickly ascertain whether or not the circuit device to be manufactured based on the input conditions has the desired function or characteristics. For this purpose, the server simulates a reliability evaluation of the circuit device to be manufactured based on the input conditions and provides the simulation results to the user terminal. The simulation of the circuit device is performed by comparing the circuit device to be manufactured by the input conditions with a plurality of circuit devices manufactured in the past and citing a reliability evaluation result of a past circuit device if the circuit device to be manufactured is identical to the past circuit device or otherwise estimating the reliability evaluation result from that of a similar circuit device. It is also possible to use a suitable circuit operation simulation software to evaluate the reliability. The reliability evaluation result may be, for example, an expected thermal discharging characteristic, an expected frequency characteristic, etc., of the circuit device as designed.

According to another aspect of the present invention, it is preferable that the system further comprises a second user terminal connected to the communication network, wherein the second user terminal comprises means for transmitting part data related to a part to be incorporated into the circuit device to the server, and the storage means accumulatively stores the part data. According to yet another aspect of the present invention, it is preferable that, in the system, the user terminal is a terminal for a device manufacturer and the second user terminal is a terminal for a part manufacturer. By connecting not only the terminal of the device manufacturer and the server via the communication network, but also the terminal of a part manufacturer of a part which may be built into the circuit device via the communication network, it is possible to obtain even higher functions of the circuit device or to further reduce cost. More specifically, the part manufacturer transmits data of its own parts from the part manufacturer terminal to the server and the storage means accumulatively stores the part data. The part data is one type of circuit device data and is provided to the user terminal. At the user terminal, the user can input conditions using the most recent part data which is continuously updated, allowing for a design of an optimal circuit device. The part manufacturer can use this opportunity to expand part sales outlets or destinations.

According to a further aspect of the present invention, there is provided a server computer used in a system for providing a circuit device, the server computer comprising storage means for storing data about a circuit device; means for creating screen data for allowing an input of a condition for manufacturing the circuit device using the data stored in the storage means and transmitting the created data to a user terminal; means for receiving, as the condition, at least CAD data of a circuit diagram, CAD data of a built-in passive part, CAD data of a built-in active part, data of an adhesive, data of external form, and data of a backside terminal from the user terminal; processor means for creating manufacturing data for manufacturing the circuit device based on the condition; and means for outputting the manufacturing data to a manufacturing facility of a circuit device.

A system and a server computer according to the present invention will be more clearly understood by referring to the following description of a preferred embodiment of the present invention. It should be noted, however, that the embodiment is described for exemplifying purpose only and the scope of the present invention is not limited to the described embodiment.

### BRIEF DESCRIPTION OF THE DRAWINGS

FIG. 1 is a conceptual diagram of a system for providing an ISB according to a preferred embodiment of the present invention.

FIG. 2 is a diagram showing a structure of the database shown in FIG. 1.

FIG. 3 is a diagram showing in more detail a structure of the database shown in FIG. 1.

FIG. 4 is a flowchart of an ISB manufacturing process.

FIG. 5 is a process flowchart in an user terminal, an ISB server, and an ISB mounting factory.

FIG. 6 is a diagram for explaining a screen displayed on a user terminal (part 1).

FIG. 7 is a diagram for explaining a screen displayed on a user terminal (part 2).

FIG. 8 is a diagram for explaining a screen displayed on a user terminal (part 3).

FIG. 9 is a diagram for explaining a screen displayed on a user terminal (part 4).

FIG. 10 is a diagram for explaining a screen displayed on a user terminal (part 5).

FIG. 11 is a diagram for explaining a screen displayed on a user terminal (part 6).

FIG. 12 is a diagram for explaining a screen displayed on a user terminal (part 7).

FIG. 13 is a diagram for explaining an example drawing of an external form.

FIG. 14 is a pattern explanation diagram corresponding to FIG. 13.

FIG. 15 is a perspective view of an ISB.

FIG. 16 is a side view of an ISB.

FIG. 17 is an explanatory diagram showing a manufacturing step of an ISB (part 1).

FIG. 18 is an explanatory diagram showing a manufacturing step of an ISB (part 2).

FIG. 19 is an explanatory diagram showing a manufacturing step of an ISB (part 3).

FIG. 20 is an explanatory diagram showing a manufacturing step of an ISB (part 4).

FIGS. 21A, 21B, and 21C are explanatory diagrams of another ISB.

### DESCRIPTION OF PREFERRED EMBODIMENT

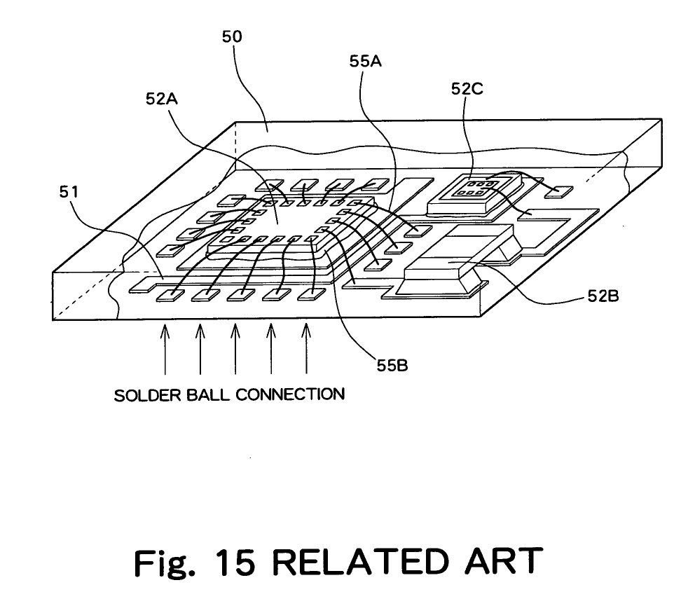

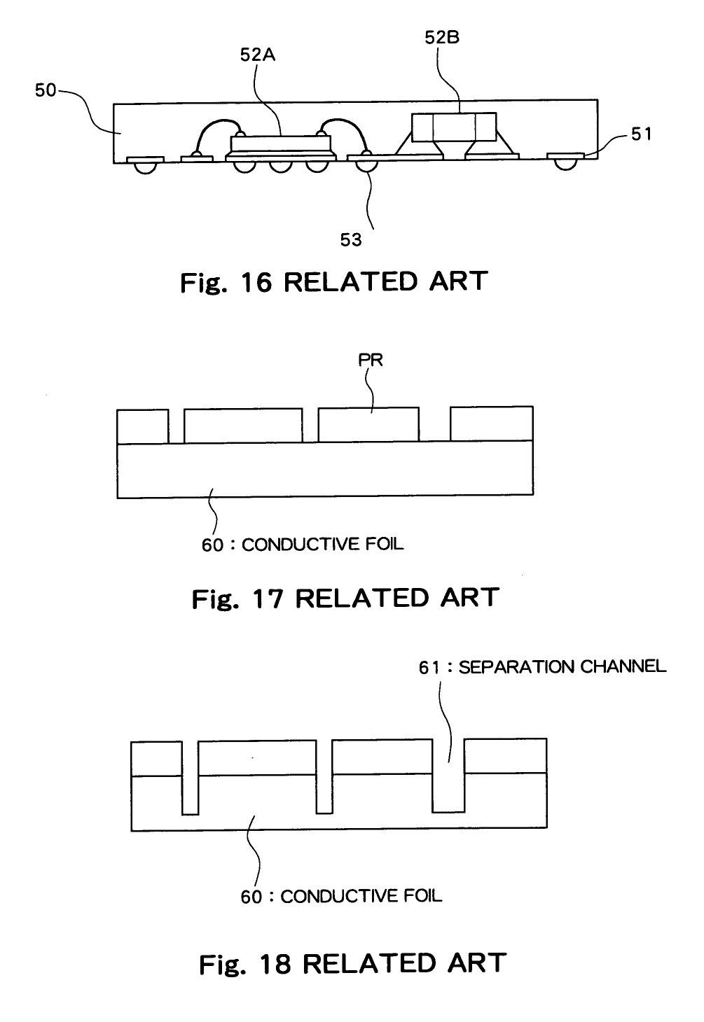

A preferred embodiment of the present invention will now be described exemplifying an ISB circuit device. Here, an “ISB circuit device” refers to a circuit device in which a plurality of circuit elements (an active part and a passive part) are covered and supported by an insulting resin without a supporting substrate as shown in FIGS. 15 and 16. Thus, the “ISB circuit device” described herein includes an SIP in a wider sense.

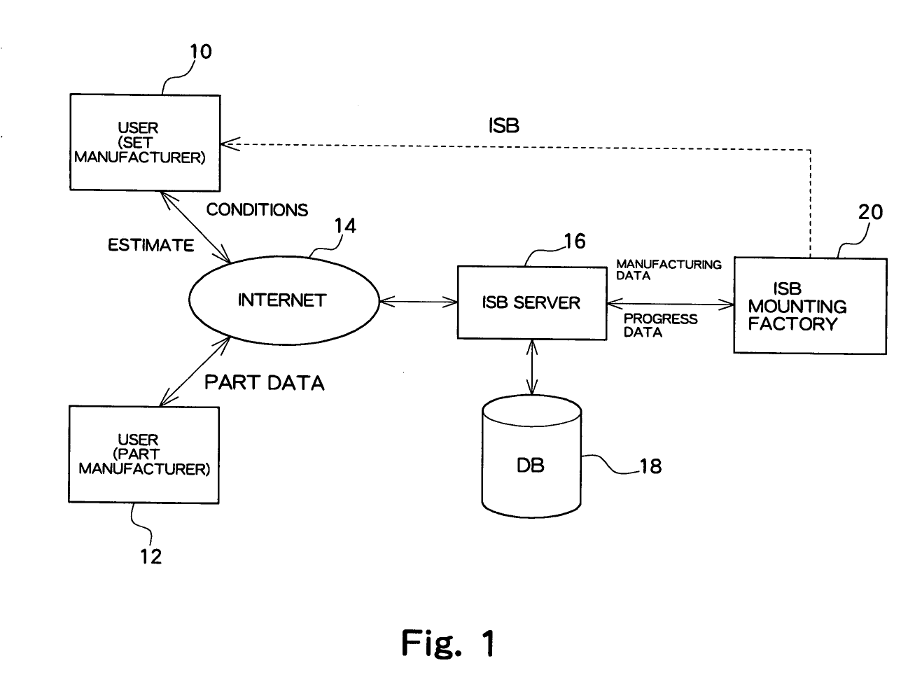

FIG. 1 conceptually shows a system for providing an ISB circuit device according to the preferred embodiment of the present invention. As shown in FIG. 1, this system comprises a user terminal (device manufacturer terminal) 10, a user terminal (part manufacturer terminal) 12, and an ISB server 16, all of which are connected to the Internet 14 as an example communication network. The ISB server 16 has a database DB 18, which may also be considered as a part of the ISB server 16. The ISB server 16 is electronically connected, possibly through a public network such as the Internet, to an ISB mounting factory 20 which manufactures an ISB requested by the user (device manufacturer) using manufacturing data from the ISB server 16 and provides the ISB to the device manufacturer. When the ISB server 16 and the ISB mounting factory 20 are connected through a communication network, it is also possible to consider the ISB mounting factory 20 as a part of the system. Although information may be exchanged between the ISB server 16 and the ISB mounting factory 20 using other, indirect or off-line, means, in view of automation of the system it is preferable that the ISB server 16 and the ISB mounting factory 20 (more specifically, a terminal which is located at the foremost position of an ISB manufacturing line within the ISB mounting factory 20) be connected on-line.

The user terminal 10 may be a personal computer, a workstation, or a dedicated terminal having a wired or wireless network interface. A user transmits necessary data of an ISB circuit device via the Internet 14 to the ISB server 16. The conditions that must be satisfied by the ISB circuit device can be input and transmitted by the user filling each item of a web page created by the ISB server 16. For this purpose, a known web browser is installed to the user terminal 10. A CAD data file created by the user (device manufacturer) may be attached to the web page as necessary. The ISB server 16 receives the transmitted condition data of the ISB circuit device.

The ISB server 16 has a known structure of a server computer, that is, the ISB server 16 comprises an input/output interface, a processor, and a memory such as a ROM and a RAM. The ISB server 16 creates, using the processor, manufacturing data necessary for the ISB mounting factory 20 to manufacture an ISB circuit device based on the conditions received from the user terminal 10 and provides the manufacturing data to the ISB mounting factory 20. The manufacturing data is data necessary for executing an ISB manufacturing process as already described. More specifically, the manufacturing data is mask data for manufacturing a photo resist PR, circuit arrangement data, coordinate data for performing wire bonding, and so on.

The database 18 accumulatively stores as a library the conditions input from the user terminal 10. The database 18 also stores the manufacturing data created based on the conditions in correspondence to the conditions. The database 18 also stores, as a library, various CAD data of circuit diagrams, pattern data of a circuit element, material information data regarding a wire and an adhesive, and external form and backside terminal data of the ISB. The ISB server 16 refers to the CAD data of circuit diagrams, external form data, etc. as reference data to be used when a circuit diagram and a mask are to be designed based on the conditions input from the user. The database 18 also accumulatively stores, as a library, part data sent from the user terminal 12 connected to the Internet 14. The part data transmitted from the user terminal 12 is used as part data when manufacturing data is created and also when a web page is created. In other words, the part data is used as part sample data when a user inputs conditions from the user terminal 10. A part manufacturer registers with the database 18, via the Internet 14, characteristic data and CAD data of parts such as an IC, an LSI, and a chip CR to be mounted in an ISB, the name of the manufacturer, price, etc. The ISB server 16 provides these part data registered in the database 18 to the user terminal 10 to allow easier input of the conditions by the user by suitably selecting the necessary part data from the provided data. This configuration provides advantages to the device manufacturer in that the device manufacturer can input necessary ISB conditions on the Internet 14 and for the part manufacturer in that the part made by the part manufacturer can be used in an ISB desired by the device manufacturer. The user terminal 12 need not be directly in contract with the ISB manufacturer, and registers, as appropriate, part data which complies with a basic ISB specification announced by the ISB manufacturer.

A characteristic of the system of the embodiment is that the system is open to any arbitrary part manufacturer. Today, regarding industrial products such as computers and automobiles, an electronic auction system of parts are being developed to contribute to achieving higher performance and reduced cost. The present system applies this concept to ISB manufacturing. By providing a system in which not only a part manufacturer who is in contract with the ISB manufacturer can participate, but also other part manufacturers, it is possible to provide advantages both to the device manufacturers and the part manufacturers.

The flow of data between each device will now be briefly described. Condition data is transmitted from the user terminal 10 to the ISB server 16. The ISB server 16 returns estimate data with respect to the conditions. On the other hand, part data for a part to be built into an ISB circuit device is transmitted from the user terminal 12. Manufacturing data is provided by the ISB server 16 to the ISB mounting factory 20 and, in return, the ISB mounting factory 20 transmits progress status data to the ISB server 16. When the ISB server 16 returns estimate data to the user terminal 10 and when the ISB server 16 creates the manufacturing data, the ISB server 16 accesses the database DB 18 to read necessary data.

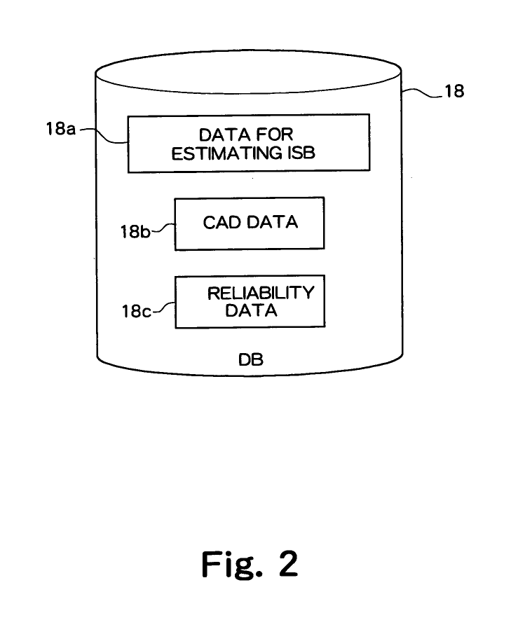

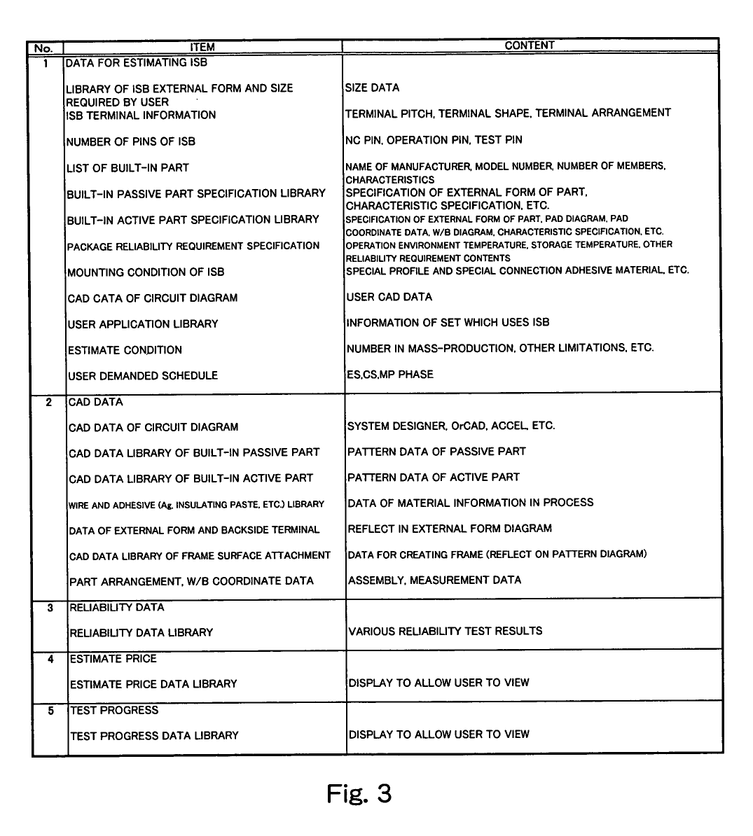

FIGS. 2 and 3 show data to be stored in the database 18 of FIG. 1. As shown in FIG. 2, the data to be stored in the database 18 can be generally classified into ISB estimate data 18a, CAD data 18b, and reliability data 18c.

The ISB estimate data 18a data specifying the required ISB as input from the user terminal 10. Based on these conditions, or specifications, manufacturing data is created. Specifically, information on external size of ISB, terminal information, number of pins, list of built-in parts, specification library for built-in passive parts, specification library for built-in active parts, package reliability requirement specification, ISB mounting conditions, CAD data of circuit diagrams, user application data, estimate conditions, and desired schedule are stored. The external size is defined, for example, by the length, width, and height of the ISB exterior and the terminal information is defined by the terminal shape and terminal arrangement. The built-in part list is a list of parts to be mounted on the ISB and is defined by the name of the manufacturer, model number, characteristics, etc. of each part.

As described, by registering, in the database 18, part data of the part manufacturers in advance and providing the part data to the user, it is possible to provide a wider selection of built-in parts to the user and facilitate and accelerate creation of the list. The package reliability requirement specification represents conditions necessary for reliability such as an operational environment temperature and storage temperature. The ISB mounting condition represents an item when a special profile or a special adhesive material or the like is to be used. The CAD data of circuit diagram is circuit diagram data created by the user using a CAD software owned by the user. The user application data is information on the device into which the ISB is to be incorporated (for example, a portable phone, an amplifier, a tuner, a power supply unit, a DSP, an MP3 player, an MD player, a CD/DVD driver, etc.).

The CAD data 18b is data for designing a pattern and a mask based on the conditions to create the manufacturing data. Specifically, the CAD data 18b is CAD data of a circuit diagram, CAD data of a built-in passive part, CAD data of a built-in active part, data of a wire and adhesive (Ag, insulating paste, etc.), and data of external form and backside terminals. Mask data (frame CAD data), part arrangement data, wire bonding (W/B) coordinate data, and so on are stored as manufacturing data produced in the past. The ISB server 16 uses this data and designs a mask based on a rule for designing a pattern from a circuit design and a design rule for designing a mask from the pattern design. Techniques for designing a pattern from a circuit diagram and for designing a mask from a pattern diagram are known and will not be described. As will be described later, it is also possible to provide design rules accumulated in the ISB server 16 to the user terminal 10 in order to allow the user side to design the pattern and the mask in addition to the circuit. When the user executes the processes up to the point of the mask design, the ISB server 16 reviews the designed mask and creates manufacturing data.

The reliability data 18c is data of results of various past reliability tests for a plurality of ISB circuit devices and is used to evaluate reliability of an ISB circuit device to be newly manufactured. In other words, when the ISB circuit device to be newly manufactured is identical to an ISB device which has been manufactured in the past, the ISB server 16 cites the test results of the ISB circuit device to evaluate, and otherwise, the ISB circuit device is evaluated by estimating from the test results of ISB circuit devices which are similar to the ISB circuit device to be manufactured. The ISB server 16 communicates the obtained evaluation results to the user terminal 10.

Among this data, the circuit diagram data, pattern data, and performance test data regarding the manufactured ISB circuit devices are continuously accumulated and registered as a database. When the user (device manufacturer) permits, it is also possible to make these data public and to be used as a reference for other device manufacturers. For example, when a device manufacturer desires an ISB circuit device for a power supply unit in a product A, by publicizing the circuit diagram data, pattern data, external size, terminal information, and test results regarding the ISB circuit device of the power supply unit, it is possible for another device manufacturer to consider the possibility of using the ISB circuit device to an ISB circuit device of a power supply unit in a different product, product B.

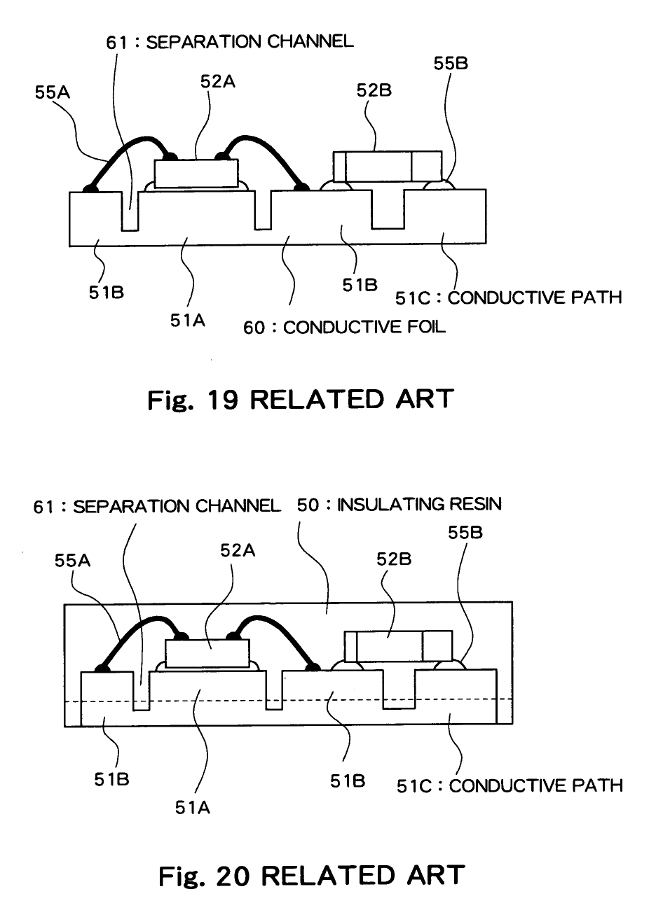

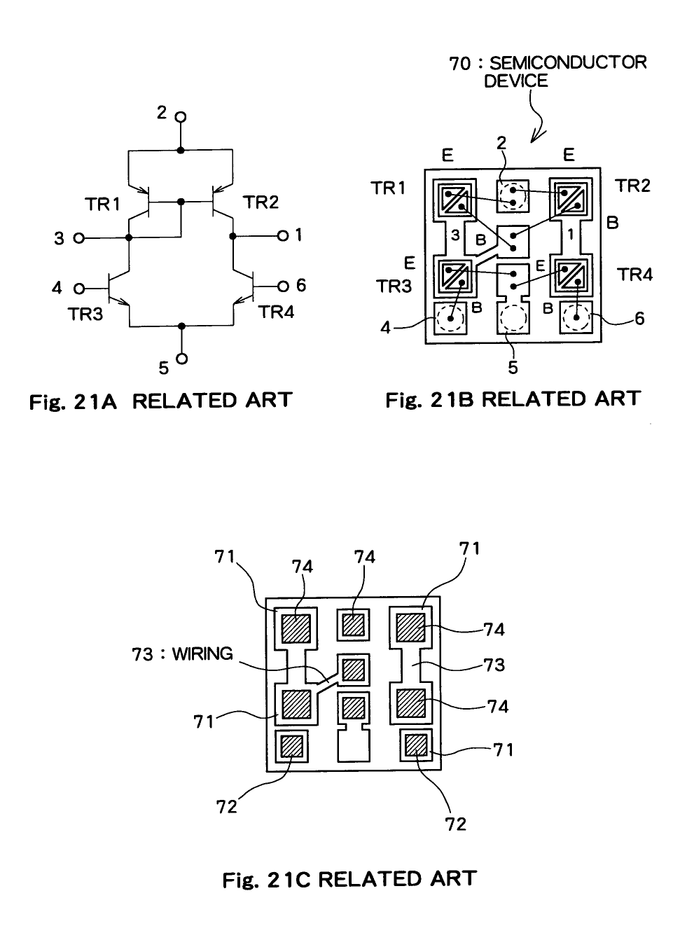

In addition to this data, the database 18 also stores data regarding estimated price and data regarding progress status. The estimated price data is data for calculating an estimated price of an ISB circuit device to be manufactured based on the conditions input by the user and, for example, a price is stored for each part. The test progress status data stores progress status data supplied from the ISB mounting factory 20 after the manufacturing data is provided. The test progress status data is provided to the user terminal 10 so as to allow the user to easily grasp the manufacturing progress status of the ISB circuit device requested by the user. The manufacturing process at the ISB mounting factory 20 includes the steps of creating photo data based on the manufacturing data provided from the ISB server 16, creating a mask based on the photo data, assembling an ISB based on the mask, and testing the performance of the ISB (refer to FIGS. 17-20). In each of these steps, the progress status is stored in the database 18.

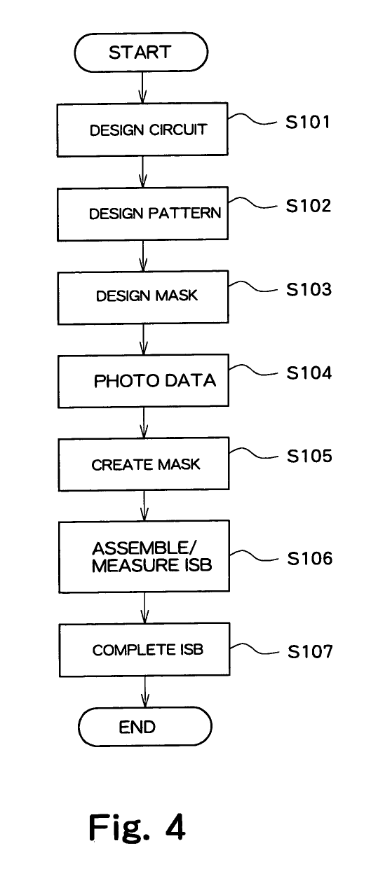

FIG. 4 shows a typical manufacturing process of an ISB circuit device. First, a circuit is designed (S101). A pattern is designed based on the circuit design (S102) and a mask for obtaining the pattern is designed based on the pattern design (S103). Conventionally, the user (device manufacturer) provided a specification or the like to the ISB mounting manufacturer and the ISB mounting manufacturer performed the processes of steps S101-S103. In the present embodiment, the user designs the circuit using online design tools made available through the world wide web, and additionally designs the pattern and mask as necessary. In other words, the ISB server 16 provides data of rules for creating pattern design data and mask design data from the circuit diagram and the user creates the pattern design data (and mask design data if necessary) and provides the data to the ISB server 16. The ISB server 16 reviews the pattern design data (and mask design data if necessary) transmitted from the user and proceeds to the next process if no problem is found. If the ISB server 16 does find a problem, the ISB server 16 informs the user of the problem, and asks the user to input new pattern design data (and mask design data if necessary).

In this manner, by employing a configuration wherein the user terminal 10 and the ISB server 16 are connected via the Internet 14, the user can control the processes, in addition to the conventional configuration wherein the user provides the specification, up through the step of designing a pattern or designing a mask, allowing for increased degree of freedom of the ISB design.

After the mask is designed, photo data for creating a photo resist PR is created based on the mask data (S104). From the photo data, a mask is created (S105) and an ISB is manufactured based on the mask (S106). After the ISB is manufactured, various performance test evaluations are performed for the obtained ISB and the ISB is completed and is delivered to the user (device manufacturer) (S107).

The processes of S104 and later are processes at the ISB mounting factory 20. It is also possible to convert the mask data into photo data at the ISB server 16 and provide the photo data to the ISB mounting factory 20. In this configuration, the processes of S101-S104 are performed by the ISB server 16.

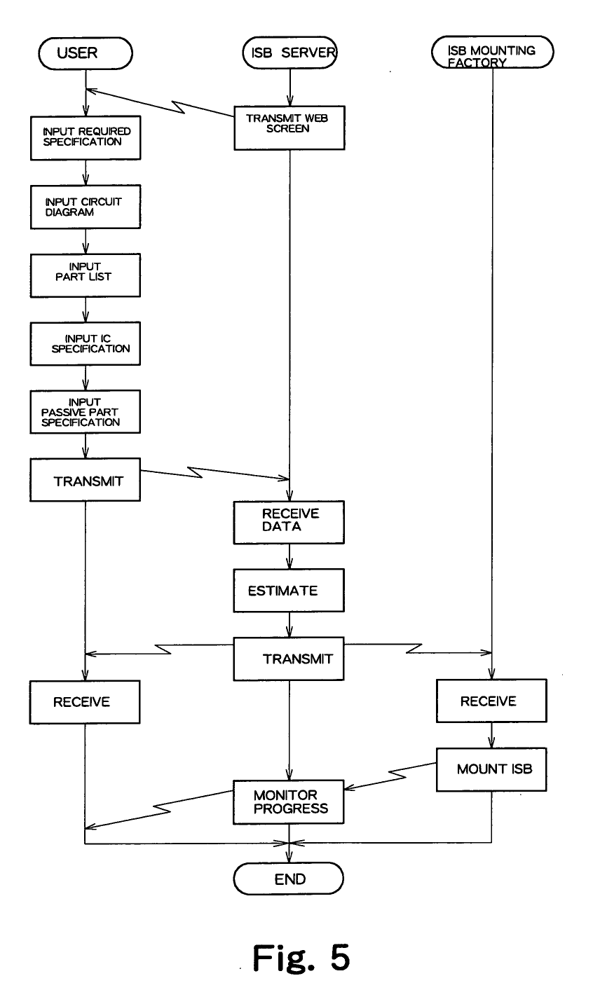

FIG. 5 shows a flowchart of an overall process in the user terminal 10, ISB server 16, and ISB mounting factory 20. The user (device manufacturer) inputs conditions that must be satisfied by the desired ISB using the user terminal 10 and transmits the conditions to the ISB server 16. Specifically, the user uses the user terminal 10 to sequentially input a requirement specification, a circuit diagram, a part list, an IC specification, and a passive part specification and transmits to the ISB server 16. A web page for allowing the user to input these items is created by the ISB server 16 and displayed on the user terminal 10. Specific details of this web page will be described later.

The ISB server 16 receives the condition data transmitted from the user terminal 10 and executes an estimate process of an ISB circuit device using a CGI. The estimate not only includes the manufacturing data of the ISB requested by the user, the delivery date, and cost, but also the performance evaluation of the ISB circuit device. That is, when the ISB circuit device to be manufactured according to the conditions transmitted from the user terminal 10 matches an ISB which is manufactured in the past and registered in the database 18, the ISB server 16 returns the test data regarding the ISB circuit device manufactured in the past to the user terminal 10.

When, on the other hand, the ISB circuit device to be manufactured according to the conditions transmitted from the user terminal 10 does not match any of the ISBs registered in the database 18, the ISB server 16 simulates the performance of the ISB circuit device to be manufactured from test data for a similar ISB circuit device and returns the simulation results to the user terminal 10. In the present embodiment, as described above, there are some cases in which the user designs the pattern or the mask online, and thus, provision of the performance evaluation data is very effective. It is also possible to employ a configuration in which the user can select whether or not they wish to obtain the “operation confirmation simulation on the web”, and to then return evaluation results only when the user indicates their desire to obtain the simulation results.

Among the estimation results, the delivery date, cost, and performance evaluation data is transmitted from the ISB server 16 to the user terminal 10, the user terminal 10 receives this data, and the data is displayed on the terminal. The manufacturing data such as the mask data, part arrangement data, and wire bonding data is transmitted to the ISB mounting factory 20. The ISB mounting factory 20 receives the manufacturing data from the ISB server 16 and proceeds to the mounting process of the ISB. More specifically, the ISB mounting factory 20 converts the data of the mask data contained in the manufacturing data to create photo data (as described above, this step may alternatively be performed by the ISB server 16), creates a mask based on the photo data to form a pattern of a conductive path 51, fixes a circuit element on the conductive path 51, connects through wire bonding, and covers with an insulating resin 50 to manufacture the ISB (refer to FIGS. 17-20). The progress status in the ISB mounting process is supplied to the ISB server 16 which further transmits the data to the user terminal 10.

The user terminal 12 transmits part data to the ISB server 16 at a suitable timing to register part data to the database 18. It is also possible to show data of the ISB circuit device and built-in parts manufactured in the past to the user terminal 12 to a degree permitted by the user (device manufacturer). The user (part manufacturer) can effectively obtain knowledge of the part which is currently required. It is also possible to allow the user (device manufacturer) to select public/non-public status of data for the ISB circuit device when the conditions are input.

A specific example of a web page for display on the user terminal 10 will now be described. The web page is only an example of a condition input screen and any page written in a language other than the HTML (for example, XML) may be equivalently employed.

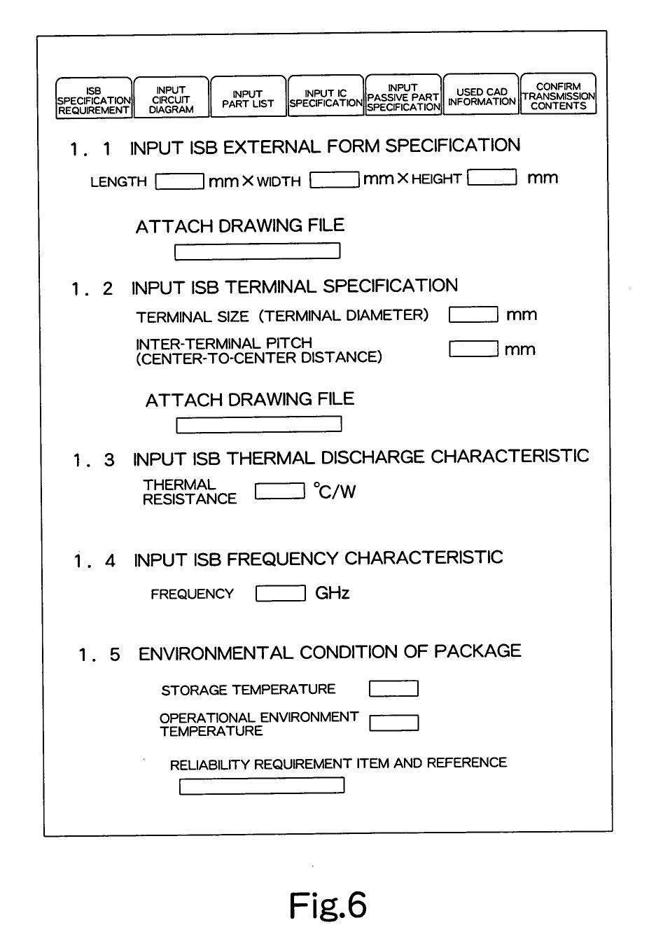

FIG. 6 shows an initial screen displayed on the user terminal 10 when a user accesses the ISB server 16 using the user terminal 10. An authentication process (input of ID or password) during the accessing is well known and will not be described. Tabs are shown at the upper section of the screen such that the user can select one of “ISB specification requirement”, “input circuit diagram”, “input part list”, “input IC specification”, “input specification of passive part”, “information of used CAD”, and “confirmation of transmission content”. Initially, the ISB specification requirement screen is displayed. The ISB specification requirement is a basic specification of an ISB desired by the user. Specifically, the ISB specification requirement includes a specification of the external form of the ISB, a specification of ISB terminal, a thermal discharge characteristic of ISB, a frequency characteristic of ISB, and package environment conditions. As the specification of the external form of the ISB, for example, the sizes of length, width, and height are input using keys in units of mm. When the external form of the ISB is of a special shape, the user attaches a drawing file which is created in advance. As the specification of the ISB terminal, terminal size (terminal diameter) and inter-terminal pitch (center-to-center distance) are input using keys in units of mm. When the ISB terminal has a special shape, a drawing file may be attached. As the thermal discharge characteristic of the ISB, a thermal resistance is input using keys in units of ° C./W. As the frequency characteristic of ISB, a frequency is input using keys in units of GHz. As the package environment conditions, a storage temperature, an operational environment temperature, a reliability requirement item, and references for these parameters when such references exist are input.

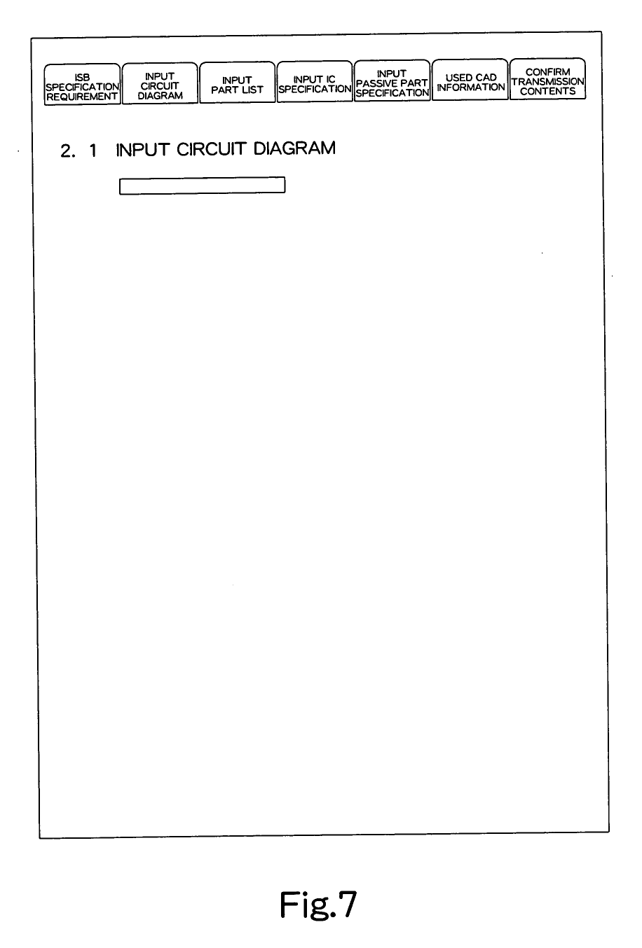

FIG. 7 shows an example screen when the “input circuit diagram” tab shown in FIG. 6 is selected by the user. The user inputs CAD data of the circuit diagram on this screen. More specifically, the user attaches, as a file, CAD data of the circuit diagram prepared in advance. For the CAD data of the circuit diagram, for example, a dxf format is used.

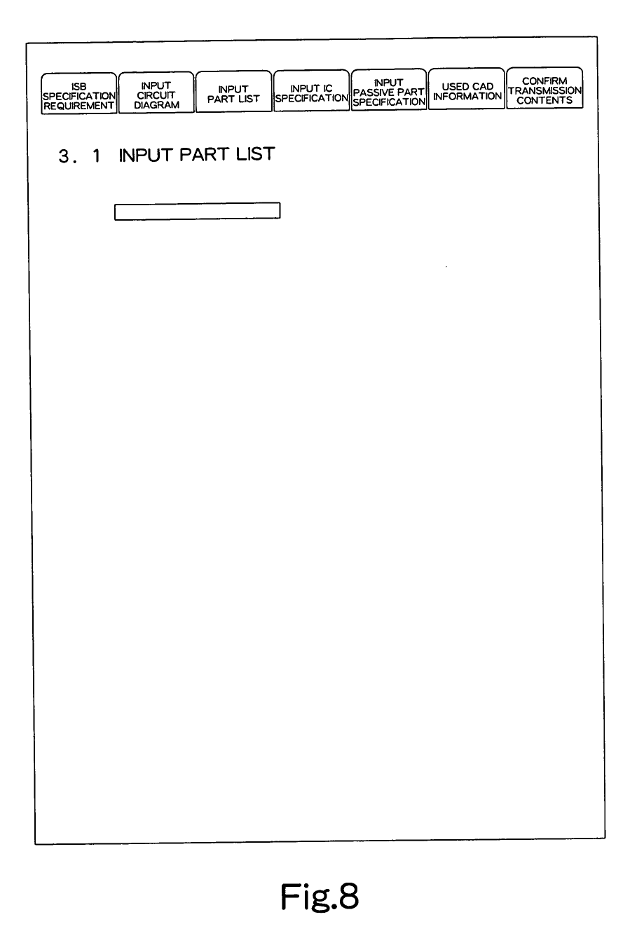

FIG. 8 shows an example screen when the user selects the “input part list” tab in FIG. 6. The user inputs the part list on this screen. The “parts” include an active part such as an IC and an LSI and a passive part such as a chip CR. When the user has prepared a part list file in advance, the user attaches the list file. Although not shown in FIG. 8, it is also possible to create a “refer sample” button within the page and display a list of part data from the part manufacturers which are already registered in the database 18, when the user operates on the sample button to allow the user to create and input a part list by selecting parts from the part data list. For the part list, for example, the xls format, the pdf format, or the doc format is used.

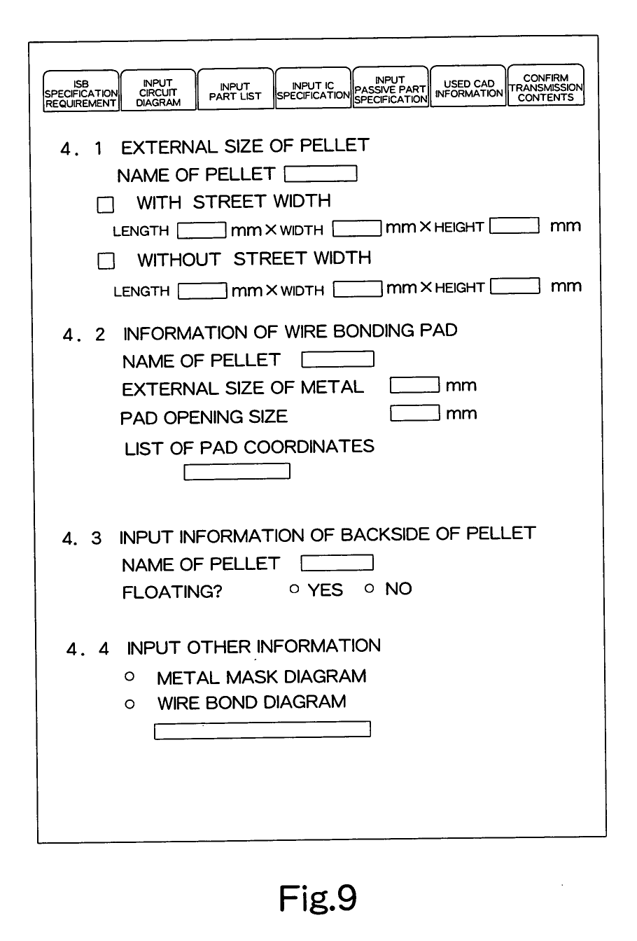

FIG. 9 shows an example screen when the user selects the “input IC specification” tab shown in FIG. 6. The IC specification includes information on the external size of an IC (including LSI) pellet, wire bonding pad information, information on the backside of the pellet, and other information. For the external size of the pellet, the user inputs the length, width, and height of the pellet using keys in units of mm along with the name of the pellet. It is also possible to distinguishingly input, when the size is input, depending on whether or not the street width is included. As the wire bonding pad information, the user inputs, using appropriate keys, the external size of the metal and size of the pad opening in units of mm along with the name of the pellet. It is also possible for the user to attach a file of a list of pad coordinates. As the backside information of the pellet, the user inputs as to whether or not the backside of the pellet is in the condition of floating along with the name of the pellet. As the other information, a drawing file of a metal mask drawing or a wiring bond drawing is input as an attachment file when the user has these drawings.

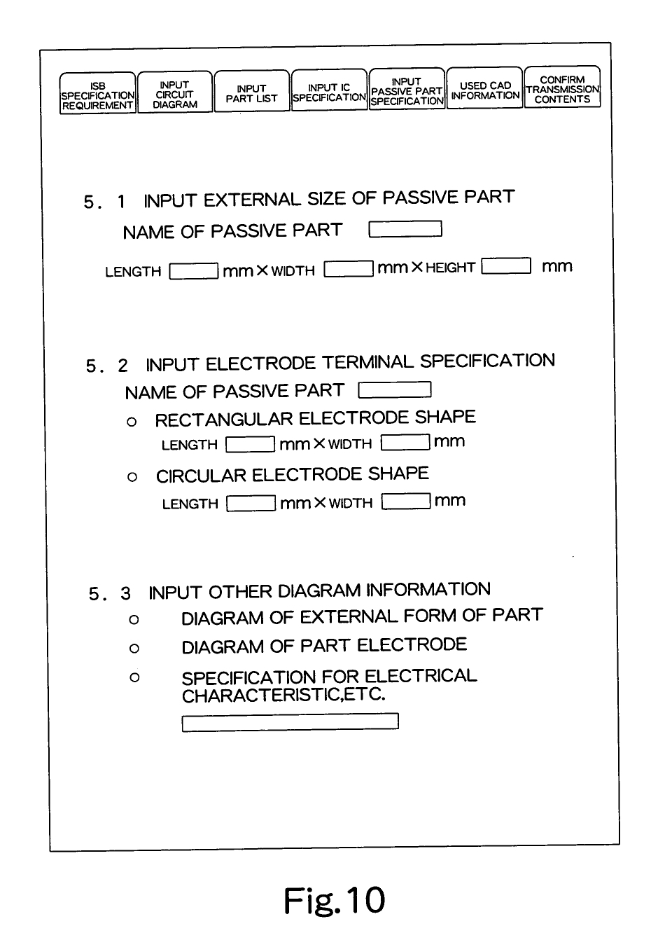

FIG. 10 shows an example screen when the user selects the “input passive part specification” tab shown in FIG. 6. The passive part specification includes the external size of the passive part, electrode terminal specification, and other information. For the external size of the passive part, the length, width, and height of the passive part are input using keys in units of mm along with the label or name of the passive part. For the electrode terminal specification, the length and width of the electrode shape is input using keys in units of mm along with the name of the passive part. It is also possible to distinguishingly input based on whether the electrode shape is quadrangle or circular. As the other drawing information, the user inputs as an attachment file drawings of the external shape of the part or of electrode of the part or specification on the electrical characteristic or the like, when the user has this information.

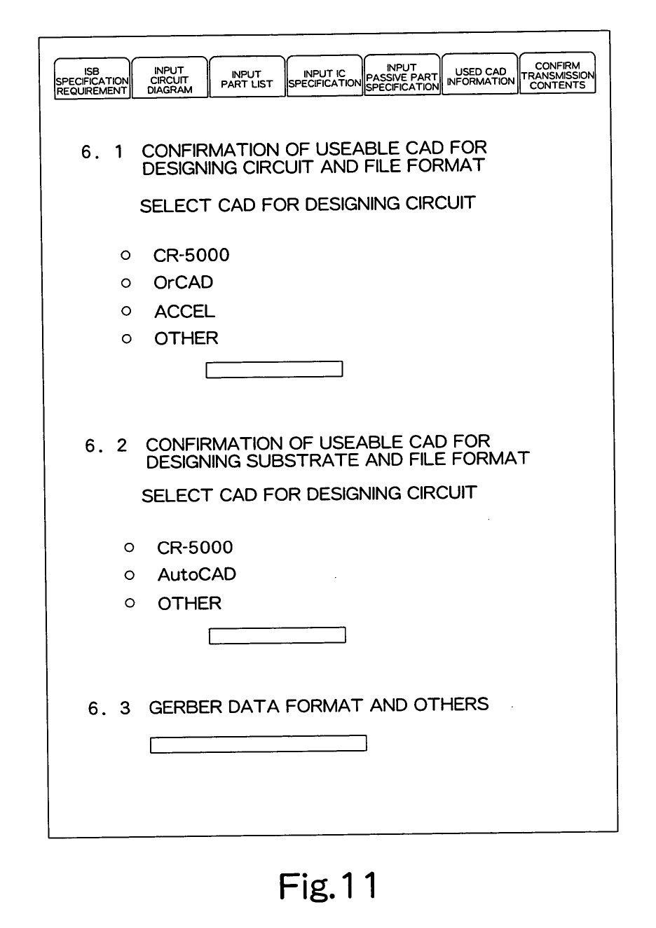

FIG. 11 shows an example screen which is displayed when the user selects the “information on used CAD” tab on FIG. 6. The user inputs the usable CAD and file format on this screen. More specifically, the user selects the circuit designing CAD and usable substrate designing CAD. For the circuit designing CAD, for example, CR-5000, OrCAD, ACCEL, and others are displayed to allow the user to select from among these choices. It is also possible to input Gerber data format or the like along with the selection.

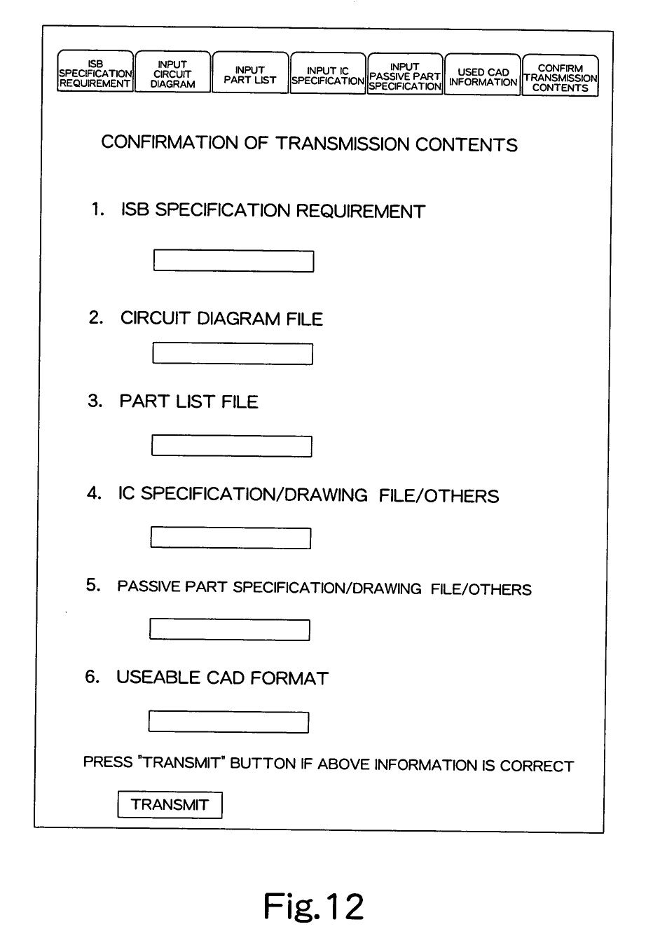

FIG. 12 shows an example screen when the user selects the “confirm transmission content” tab on FIG. 6. The data items input in each screen of FIGS. 6-11 are displayed as a list, so that the user can review this screen before finally confirming the transmission content. When the transmission content is acceptable, the user clicks on the transmission button to transmit the specifications for the ISB to the ISB server 16.

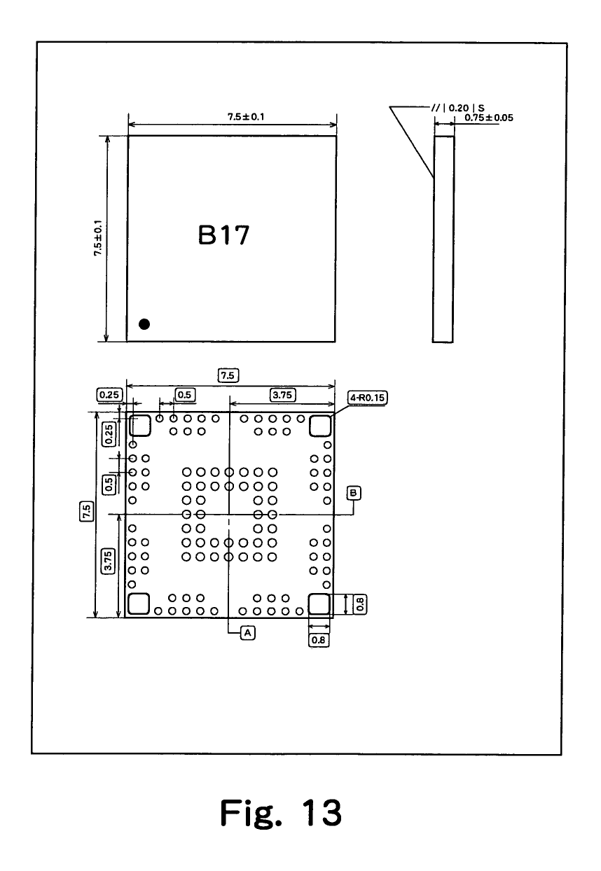

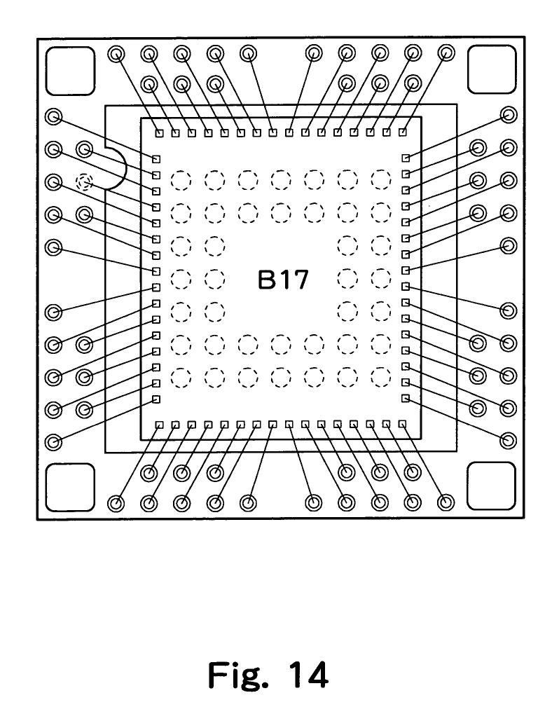

FIG. 13 shows an example drawing of an external form input by the user, and FIG. 14 shows an example pattern drawing created based on the external form drawing.

In this manner, in the present embodiment, the user (device manufacturer) can obtain a desired ISB by merely inputting conditions of the ISB through the user terminal 10. In addition, because the user can input the conditions on the web, it is possible for the user to not only design the circuit, but also design the pattern or the mask to provide the ISB specification to the ISB manufacturer through an interactive conversation with the ISB server 16. With this configuration, the user can reliably obtain the desired ISB. In addition, conditions of ISB transmitted by a certain user (device manufacturer) to the ISB server 16 are accumulatively stored in the database 18 and registered as a library. When the user desires, the ISB specification may be made public and provided to other users as a sample. With this structure, convenience for the other users can be improved. Moreover, because part manufacturers who manufacture and sells parts to be mounted in the ISB circuit device are also connected to the network, the present embodiment can provide advantages to the part manufacturers in that the part manufacturers can use the system for expanding sales routes for their parts. With this configuration, it is possible to improve the performance of parts and reduce the cost of parts, which consequently allows for improvements in the performance of the ISB circuit device and reduction in the cost of the ISB circuit device.

A preferred embodiment of the present invention has been described. The present invention, however, is not limited to the described embodiment, and various modifications can be made without departing from the scope and sprit of the present invention.

For example, as an ISB circuit device, in addition to a structure having a single-layer wiring layer, it is also possible to employ a structure having multi-layered wiring, and it is further possible to employ a configuration in which the user can select a single-layer structure or a multi-layer structure when the user inputs conditions of the ISB circuit device from the user terminal 10. Alternatively, it is also possible for the ISB server 16 to automatically determine whether to employ a single-layer structure or a multi-layer structure based on the external size, thermal discharge characteristic, and frequency characteristic input by the user and design a pattern. In general, when the thermal characteristic and compliance to multi-pins are of greater priority, a single layer structure may be selected and when a high-density mounting, that is, the external size is of greater priority, a multi-layer structure may be selected.

What is claimed is:

1. A system for providing a circuit device to a user using a server and a user terminal connected to a communication network, wherein
the user terminal comprises:
input means for inputting a condition to be satisfied by the circuit device; and
transmission means for transmitting the condition via the communication network to the server,
the server comprises:
receiver means for receiving the condition transmitted from the user terminal;
storage means for storing circuit device data related to the circuit device;
processor means for providing at least a portion of the circuit device data to the user terminal as a sample and for creating manufacturing data of the circuit device based on the condition received from the user terminal and the circuit device data; and
output means for outputting the manufacturing data to a manufacturing facility of the circuit device, and
the storage means stores, as the circuit device data, at least CAD data of circuit diagram, CAD data of a built-in passive part, CAD data of a built-in active part, adhesive data, external form data, and backside terminal data regarding the circuit device.

2. A system according to claim 1, wherein
the user terminal transmits, as the condition, at least external form and size data, terminal data, built-in part data, and CAD data of circuit diagram regarding the circuit device to the server, and
the server creates manufacturing mask data as the manufacturing data based on the condition.

3. A system according to claim 1, wherein the storage means accumulatively stores the condition received from the user terminal and the manufacturing data.

4. A system according to claim 1, wherein
the storage means further stores data of reliability evaluation results for a plurality of circuit devices, and
the processor means evaluates the reliability of the circuit device to be manufactured from the received condition based on the reliability evaluation result.

5. A system according to claim 1, further comprising:
a second user terminal connected to the communication network, wherein
the second user terminal comprises means for transmitting part data related to a part to be incorporated into the circuit device to the server, and
the storage means accumulatively stores the part data.

6. A system according to claim 5, wherein
the user terminal is a terminal for a device manufacturer, and
the second user terminal is a terminal for apart manufacturer.

7. A system according to claim 1, wherein
the circuit device comprises a plurality of electrically separated conductive paths, a circuit element fixed on the conductive path, and an insulating resin covering the circuit element and integrally supporting the conductive path.

8. A system for providing, via a communication network, a circuit device having an IC and a passive part covered and supported by an insulating resin, wherein:
a terminal for a device manufacturer, a terminal for a part manufacturer, and a server are connected to the communication network;
CAD data of an IC or a passive part to be used in the circuit device is transmitted from the terminal for part manufacturer to the server;
the server registers at least CAD data of an IC and a passive part used in the circuit device, CAD data of the circuit diagram, data regarding wiring and adhesives, and data of external form and backside terminal of the circuit device as a library,
the server creates web screen data for inputting a condition to be satisfied by the circuit device using the data of the library and transmits the web screen data to the terminal for a device manufacturer;
at least external form and size data, terminal data, IC data, passive part data, and CAD data of a circuit diagram are transmitted as the condition to be satisfied by the circuit device from the terminal for the device manufacturer to the server; and
the server newly registers the condition as a library, creates mask data for manufacturing circuit device based on the condition, and supplies the mask data to a manufacturing facility of the circuit device.

9. A server computer used in a system for providing a circuit device, the server computer comprising:
storage means for storing data about a circuit device;
means for creating screen data for allowing an input of a condition for manufacturing the circuit device using the data stored in the storage means and transmitting the created data to a user terminal;
means for receiving, as the condition, at least CAD data of a circuit diagram, CAD data of a built-in passive part, CAD data of a built-in active part, data of an adhesive, data of external form, and data of a backside terminal from the user terminal;
processor means for creating manufacturing data for manufacturing the circuit device based on the condition and the data stored in the storage means; and
means for outputting the manufacturing data to a manufacturing facility of a circuit device.

10. A server computer according to claim 9, wherein
the manufacturing data contains mask data.

11. A server computer according to claim 9, wherein
the storage means stores data of reliability test results for a plurality of circuit devices and comprises means for evaluating, based on the reliability test result data, reliability of a circuit device to be manufactured based on the condition and transmitting the evaluation to the user terminal.
